(19) United States
(12) Patent Application Publication
(10) Pub. No.: US 2025/0302198 A1
(43) Pub. Date: Oct. 2, 2025

(54) SEATING STRUCTURE HAVING A NATURAL MATERIAL INTEGRATED WITH AN ELASTICALLY DEFORMABLE LAYER

(71) Applicant: MILLERKNOLL, INC., Zeeland, MI (US)

(72) Inventors: Shannon McDevitt, Zeeland, MI (US); John F. Aldrich, Grandville, MI (US); Jack Heideman, Zeeland, MI (US); John Curtis Groelsma, Jenison, MI (US); Justin Wilkins, Zeeland, MI (US); Keiji Takeuchi, Milan (IT)

(21) Appl. No.: 18/864,421

(22) PCT Filed: Jun. 9, 2023
(86) PCT No.: PCT/US2023/068252

§ 371 Date: Nov. 8, 2024

Related U.S. Application Data
(60) Provisional application No. 63/351,184, filed on Jun. 10, 2022.

(51) Int. Cl. A47C 5/02; A47C 7/32

(52) U.S. Cl. CPC A47C 5/02; A47C 7/32

(57) ABSTRACT

A seating structure includes a frame defining an opening, and a suspension web coupled to the frame and extending over the opening to form a seat, a backrest, or both. The suspension web includes an elastically deformable layer attached to the frame and a plurality of bamboo strips integrated with the elastically deformable layer.

### CROSS-REFERENCE TO RELATED APPLICATIONS

The present application claims priority to U.S. Provisional Patent Application No. 63/351,184, filed Jun. 10, 2022, the entire content of which is incorporated herein by reference.

### FIELD OF THE INVENTION

The present invention relates to seating structures having natural material integrated with an elastically deformable layer and, more particularly, seating structures having bamboo integrated with an elastically deformable layer.

### BACKGROUND OF THE INVENTION

Furniture, such as a chair, bench, sofa, settee, chaise, ottoman, bed, cot, and the like can be provided as seating structures. The furniture may be formed of various materials to provide a certain level of comfort to a user.

### SUMMARY

In one embodiment, a seating structure includes a frame defining an opening, and a suspension web coupled to the frame and extending over the opening to form a seat, a backrest, or both. The suspension web includes an elastically deformable layer attached to the frame, and a plurality of bamboo strips integrated with the elastically deformable layer.

In another embodiment, a seating structure includes a frame including a first frame member and a second frame member. The second frame member is spaced apart from the first member in a first direction to define an opening therebetween. The seating structure also includes a suspension web extending over the opening to form a seat, a backrest, or both. The suspension web includes a flexible layer coupled to the first frame member and the second frame member, and a plurality of bamboo strips coupled to the flexible layer. Each bamboo strip has a length and a width. The lengths of the plurality of bamboo strips extending in a second direction that is perpendicular to the first direction.

In another embodiment, a seating structure includes a frame defining an opening, and a suspension web extending over the opening to form a seat, a backrest, or both. The suspension web includes a flexible layer secured to the frame, and a plurality of bamboo strips supported by the flexible layer. Each bamboo strip has a first end and a second end. The first and second ends are movable relative to the frame.

Other aspects of the invention will become apparent by consideration of the detailed description and accompanying drawings.

### BRIEF DESCRIPTION OF THE DRAWINGS

FIG. 1 is a perspective view of a chair according to some embodiments.

FIG. 2 is an enlarged top view of a suspension web of the chair shown in FIG. 1.

FIG. 3 is an enlarged cross-sectional view of the chair shown in FIG. 1.

FIG. 4 is an enlarged perspective view of the suspension web of the chair shown in FIG. 1, with suspension straps removed.

FIG. 5 is a top view of the suspension web of the chair shown in FIG. 1, with suspension straps removed.

FIG. 6 is a perspective view of another chair according to some embodiments.

FIG. 7 is a perspective view of another chair according to some embodiments.

FIG. 8 is a top perspective view of an elastomeric segment of the chair shown in FIG. 7, in an unstretched position.

FIG. 9 is a bottom perspective view of the elastomeric segment of the chair shown in FIG. 7, in the unstretched position.

FIG. 10 is a top perspective view of the elastomeric segment of the chair shown in FIG. 7, in a stretched position.

FIG. 11 is a bottom perspective view of the elastomeric segment of the chair shown in FIG. 7, in the stretched position.

FIG. 12 is an enlarged top perspective view of the elastomeric segment of the chair shown in FIG. 7.

FIG. 13 is an enlarged bottom perspective view of the elastomeric segment of the chair shown in FIG. 7.

FIG. 14 is a perspective view of another chair according to some embodiments.

FIG. 15 is a perspective view of another chair according to some embodiments.

FIG. 16 is a top view of elastomeric segments of the chair shown in FIG. 15.

FIG. 17 is a perspective view of a stretching machine and one of the elastomeric segments of the chair shown in FIG. 15.

FIG. 18 is a perspective view of another chair according to some embodiments.

FIG. 19 is an enlarged perspective view of a suspension web of the chair shown in FIG. 18.

FIG. 20 is a perspective view of another chair according to some embodiments.

FIG. 21 is a top view of the chair shown in FIG. 20.

FIG. 22 is a top view of a suspension web of the chair shown in FIG. 20, with bamboo strips removed.

FIG. 23 is an exploded view of multiple bamboo layers for a laminated bamboo sheet.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

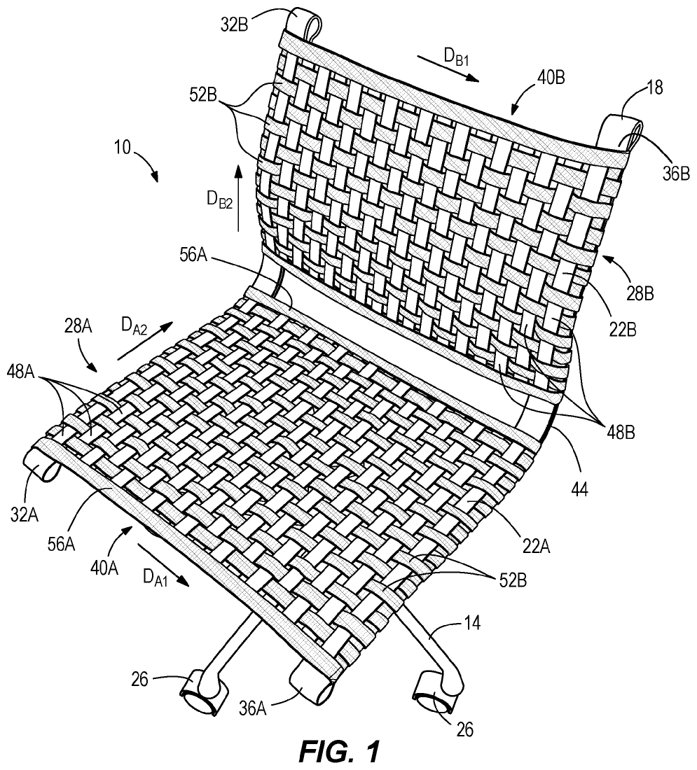

FIG. 1 illustrates a seating structure 10, such as a chair. The illustrated embodiment is only one example of a configuration of a chair. The chair may have other shapes and/or configurations. The seating structure 10 may also be a different type of furniture item, such as a bench, sofa, settee, chaise, ottoman, bed, cot, and the like. In the illustrated embodiment, the seating structure 10 is an office chair. The seating structure 10 includes a base 14, a support column, a tilt mechanism, a frame 18, a first suspension web 22A, and a second suspension web 22B. In some embodiments, the seating structure 10 may also include armrests. In the illustrated embodiment, the frame 18 is supported by the base 14 via the support column and the tilt mechanism. The frame 18 is movably coupled to the support column via the tilt mechanism. In other embodiments, the frame 18 may be rigidly coupled to the support column or the base 14. In the illustrated embodiment, the base 14 includes five arms surrounding a central hub. Each of the arms is coupled to a castor wheel 26. In some embodiments, the base 14 may include glides instead of the castor wheels 26. In other embodiments, the base 14 may include a plurality of legs. In such embodiments, the support column and/or the tilt mechanism may be omitted.

In the illustrated embodiment, the first suspension web 22A and the frame 18 form a seat 28A. The second suspension web 22B and the frame 18 form a backrest 28B. In the illustrated embodiment, the frame 18 is continuous and forms both the seat and the backrest. In other embodiments, the seating structure 10 may include a seat frame and a separate backrest frame. In some embodiments, only one suspension web may be used to form a continuous seat and backrest.

As shown in FIG. 1, the frame 18 includes a first frame member 32A, 32B and a second frame member 36A, 36B in the seat 28A and in the backrest 28B. The first frame members 32A, 32B and the second frame members 36A, 36B are mirror images of each other. The frame 18 also includes two crossbeam members which connect the first frame members 32A, 32B to the second frame members 36A, 36B at an upper end and lower end of the frame 18. The first frame members 32A, 32B are continuous and are formed as one-piece with each other. The second frame members 36A, 36B are continuous and are formed as one-piece with each other. Each of the second frame members 36A, 36B is spaced from a corresponding one of the first frame members 32A, 32B in a first direction D_{A1}, D_{B1} such that a gap 40A, 40B, or opening, is formed therebetween. The first suspension web 22A and the second suspension web 22B each extend over a respective one of the gaps 40A, 40B when the first suspension web 22A and the second suspension web 22B are coupled to the frame 18. The first frame member 32A and the second frame member 36A of the seat 28A each are elongated in a second direction D_{A2}. The second direction D_{A2} of the seat 28A is perpendicular to the first direction D_{A1} of the seat 28A. The first frame member 32B and the second frame member 36B of the backrest 28B each are elongated in a second direction D_{B2}. The second direction D_{B2} of the backrest 28B is perpendicular to the first direction D_{B1} of the backrest 28B. The second direction D_{B2} of the backrest 28B is perpendicular to the second direction D_{A2} of the seat 28A.

With reference to FIGS. 1 and 3, the frame 18 includes a first outer recess in the first frame members 32A, 32B and a second outer recess 44 in the second frame members 36A, 36B. The first and second outer recesses 44 are arranged on an outer perimeter of the frame 18. The first and second outer recesses 44 are arranged on portions of the frame 18 facing away from the gaps 40A, 40B.

The first suspension web 22A and the second suspension web 22B are substantially similar to each other. Additionally, structures of the seat 28A and the backrest 28B are substantially similar to each other. For sake of brevity, only the first suspension web 22A and the seat 28A will be described in detail. Differences between the suspension webs 22A, 22B and between the seat 28A and backrest 28B will be discussed below.

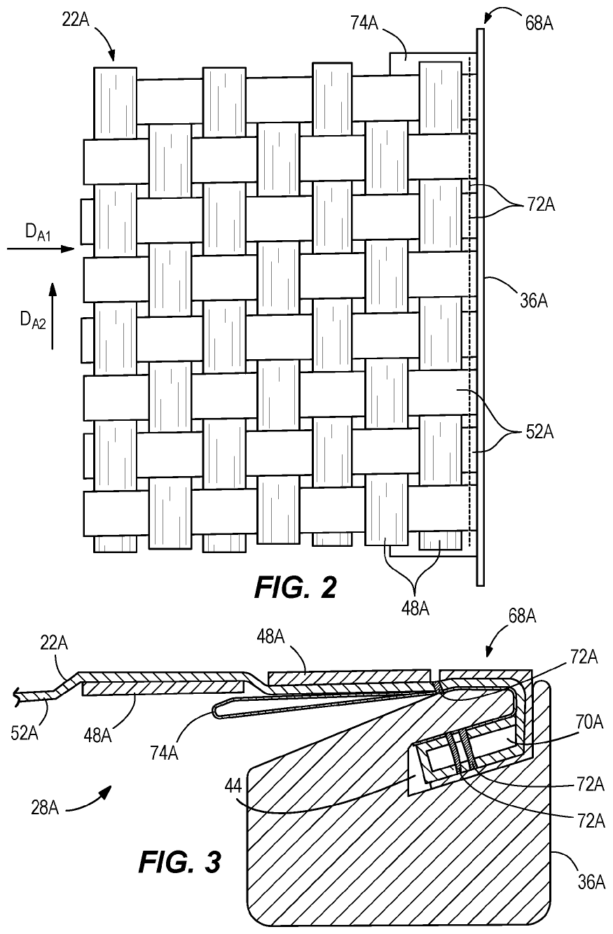

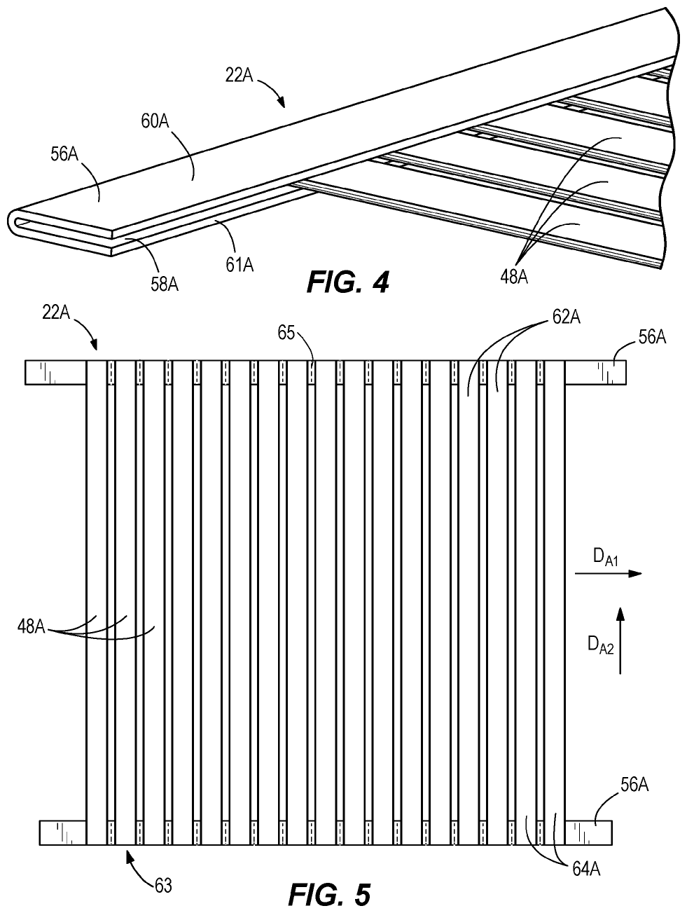

FIGS. 2 and 3 illustrate the first suspension web 22A and the seat 28A. The first suspension web 22A includes an elastically deformable layer or a flexible layer and a plurality of bamboo strips 48A. The suspension web 22A also includes caps 56A on opposite ends of the suspension web 22A (see FIGS. 4 and 5). The plurality of bamboo strips 48A are integrated with the elastically deformable layer. In other embodiments, the plurality of bamboo strips 48A may be replaced by other natural materials such as rattan, wood, or the like. In the illustrated embodiment, the elastically deformable layer includes a plurality of suspension straps 52A. “Strap” should be understood to mean an elongated narrow piece of material. Each of the plurality of suspension straps 52A is significantly longer in a length direction than in a width direction. As illustrated, the plurality of bamboo strips 48A arc woven with the plurality of suspension straps 52A. In the illustrated embodiment, the bamboo strips 48A are woven with the plurality of suspension straps 52A in a plain pattern. In other embodiments, the bamboo strips 48A and suspension straps 52A can be woven in different weave patterns such as but not limited to basket, twill, satin, oxford, houndstooth, and herringbone. In other embodiments, the bamboo strips 48A can be integrated with the plurality of suspension straps 52A in other ways such as sewing or tying the bamboo strips 48A to the plurality of suspension straps 52A. In other embodiments, the bamboo strips 48A may be layered on the suspension straps 52A. The plurality of bamboo strips 48A each have a length and a width. The length of each bamboo strip 48A extends in the second direction D_{A2} of the seat 28A. The plurality of suspension straps 52A each have a length and a width. The length of each suspension strap 52A extends in the first direction D_{A1} of the seat 28A. As such, the bamboo strips 48A are perpendicular to the suspension straps 52A. Each bamboo strip 48A is spaced apart from adjacent bamboo strips 48A, forming small gaps between the bamboo strips 48A. In some embodiments, the bamboo strips 48A may be spaced apart by less than 5 mm. In other embodiments, the bamboo strips 48 may be spaced apart by less than 3 mm.

The illustrated suspension straps 52A are formed from suspension material. The suspension material may be made of a woven or knit material, including various elastomeric materials, fabrics, or various molded polymeric materials. The suspension material can include one or more monofilaments interlaced with one or more multifilament strands. The monofilaments may be thermoplastic elastomer (TPE) yarns. A TPE yarn may include a single extruded filament or multiple extruded filaments that are clustered or bundled together like a rope or cable. In some embodiments, the suspension material can include a single monofilament with a plurality of multifilament strands. Alternatively, the suspension material can include only monofilaments and no multifilament strands. The monofilaments can be the primary load carrying members and run laterally in the warp direction of the suspension straps 52A. The multifilament strands run longitudinally in the weft direction. Additionally, monofilaments and/or multifilament may be combined to run in both the lateral and longitudinal directions if necessary. In the illustrated embodiment, the monofilaments of the suspension straps 52A run in the first direction D_{A1} of the seat 28A. In other words, the primary load carrying members of the seat 28A are elongated in the first direction D_{A1} of the seat 28A. In other embodiments, the monofilaments of each suspension strap 52A may vary in stiffness to withstand movement of a user.

FIGS. 4 and 5 illustrate the bamboo strips 48A and the caps 56A of the first suspension web 22A. The caps 56A are opposite to each other and are spaced apart in the second direction D_{A2} of the seat 28A. In the illustrated embodiment, the caps 56A are formed by folding a suspension strap lengthwise to form a pocket 58A. Each cap 56A includes a first half 60A and a second half 61A which define the pocket 58A. In other embodiments, the caps 56A can be formed from other materials, such as another fabric, a plastic, or an elastomeric material. In other embodiments, the caps 56A can be formed from other methods such as, sewing, 3D-knitting, 3D-printing or injection molding.

Each of the bamboo strips 48A has a first end 62A and a second end 64A opposite the first end 62A. The bamboo strips 48A each are elongated between the first ends 62A and the second ends 64A. The first ends 62A of the plurality of bamboo strips 48A are disposed in the pocket 58A of a first one of the caps 56A. The second ends 64A of the plurality of bamboo strips 48A are disposed in the pocket 58A of a second one of the caps 56A. The first half 60A and the second half 61A of the first one of the caps 56A sandwich the first ends 62A of the bamboo strips 48A. The first half 60A and the second half 61A of the second one of the caps 56A sandwich the second ends 64A of the bamboo strips 48A. The first ends 62A and second ends 64A of the plurality of bamboo strips 48A are movable inside the caps 56A. When the first suspension web 22A is coupled to the frame 18, the first ends 62A and second ends 64A are movable relative to the frame 18. In other words, the bamboo strips 48A are not directly connected or secured to the frame 18. The pockets 58A are sized such that the caps 56A are flexible and such that the first and second ends 62A, 64A are movable relative to the frame 18. The movability of the first and second ends 62A, 64A of the bamboo strips 48A allow the bamboo strips 48A to contour to a body of a user sitting in the chair 10 without breaking or failing.

In the illustrated embodiment, the caps 56A are sewn such that each of the ends 62A, 64A is positioned in a sub-pocket 63 of the pockets 58A. The caps 56A have stitches 65 in between each of the bamboo strips 48A. The ends 62A, 64A are secured in the caps 56A such that the ends 62A, 64A do not move out of the pockets 58A when a user sits on the seating structure 10. In some embodiments, the ends 62A, 64A are sewn, glued or tied on to the caps 56A such that the ends 62A, 64A are not easily removable from the caps 56A. In some embodiments, the pockets 58A may simply be deep enough such that the ends 62A, 64A cannot easily be removed from the caps 56A. In some embodiments, the bamboo strips 48A are bonded to the first suspension web 22A by an adhesive. Specifically, the ends 62A, 64A of each bamboo strip 48A are bonded to the caps 56A of the first suspension web 22A. The adhesive is arranged along an edge of each end 62A, 64A so that the ends 62A, 64A may be constrained to a respective sub-pocket 63.

Referring back to FIGS. 2 and 3, the first suspension web 22A is coupled to the frame 18 via attachment structures 68A on each side of the suspension web 22A. While only the connection between the first suspension web 22A and the second frame member 36A of the seat 28A is shown, it should be understood that the attachment structure between the first suspension web 22A and the first frame member 32A is a mirror image of the attachment structure 68A shown in FIGS. 2 and 3. In the illustrated embodiment, the suspension straps 52A are directly coupled to the frame 18, and the bamboo strips 48A are indirectly coupled to the frame 18 via the suspension straps 52A. Each of the attachment structures 68A includes a strip 70A, a plurality of stitches 72A, and a beam or frame cover fabric 74A. The strip 70A can be a keder strip. Each of the suspension straps 52A is partially wrapped around the strip 70A. The suspension straps 52A each are sewn to the strip 70A via the plurality of stitches 72A. The beam cover fabric 74A is sewn to the suspension straps 52A via the plurality of stitches 72A.

When the suspension web 22A is coupled to the frame 18, the strip 70A and portions of the suspension straps 52 which are partially wrapped around the strip 70A are inserted into the recess 44 of the second frame member 36A of the seat 28A. The recess 44 retains the strip 70A to secure the suspension web 22A to the frame 18. When the strip 70A is inserted in the recess 44, the suspension straps 52A wrap around a portion of the second frame member 36A of the seat 28A. The beam cover fabric 74A is positioned between the suspension web 22A and the frame 18. The beam cover fabric 74A helps cover the frame 18 for aesthetics and/or cushioning. In other embodiments, the suspension web 22A may be coupled to the frame 18 using other suitable attachment structures. For example, the suspension web 22A may be coupled to the frame 18 by fasteners (e.g., screws, rivets, staples, snaps, etc.), may be molded into the frame 18, may be sandwiched between frame members, and the like.

Referring back to FIG. 1, the configurations and connections of the second suspension web 22B and the backrest 28B are substantially the same as the first suspension web 22A and the seat 28A. The backrest 28B has a different length and width from the seat 28A. In the illustrated embodiment, the second suspension web 22B has less suspension straps 52A than the first suspension web 22A. In other embodiments, the second suspension web 22B can have more of or the same amount of suspension straps 52A as the first suspension web 22A. In some embodiments, the second suspension web 22B may have more or less bamboo strips 48B than the first suspension web 22A. In the illustrated embodiment, the webs 22A, 22B have an equal number of bamboo strips 48A, 48B. In some embodiments, material of the suspension straps 52A of the first suspension web 22A may be different from material of the suspension straps 52B of the second suspension web 22B. In some embodiments, the material of the suspension straps 52A of the first suspension web 22A may be the same as the material of the suspension straps 52B of the second suspension web 22B. In some embodiments, the suspension straps 52A of the first suspension web 22A may have more monofilaments per square inch than the suspension straps 52B of the second suspension web 22B. In some embodiments, the suspension straps 52A of the first suspension web 22A may have less monofilaments per square inch than the suspension straps 52B of the second suspension web 22B. In some embodiments, the suspension straps 52A of the first suspension web 22A may have the same number of monofilaments per square inch as the suspension straps 52B of the second suspension web 22B.

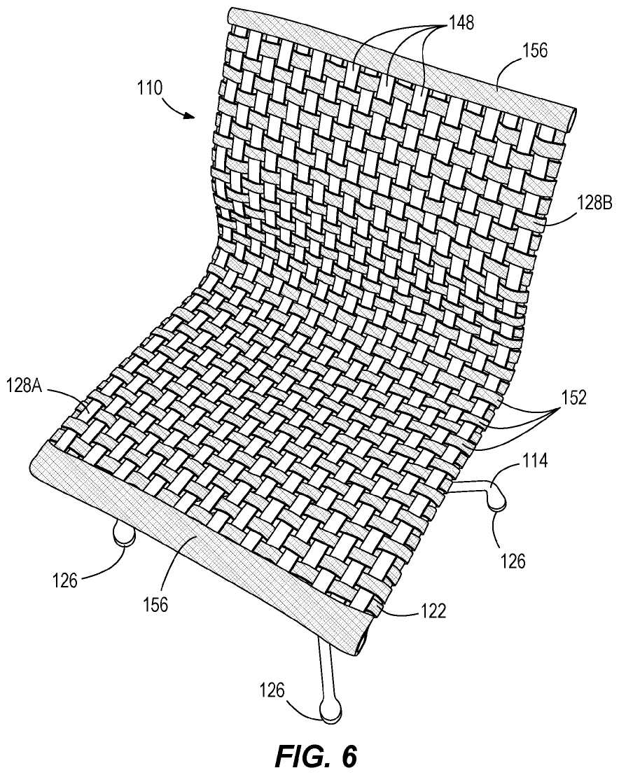

FIG. 6 illustrates another chair 110. The chair 110 is similar to the chair 10 described above and includes a base 114, a support column, a tilt mechanism and a frame. Unlike the chair 10, the chair 110 has a plurality of glides 126 on the base 114. Unlike the chair 10, the chair 110 includes a single suspension web 122 which in combination with the frame forms a continuous seat 128A and backrest 128B. The single suspension web 122 includes a plurality of bamboo strips 148 woven with a plurality of suspension straps 152. The plurality of bamboo strips 148 are bent such that the plurality of bamboo strips 148 has the same contour as the frame. The plurality of bamboo strips 148 is contoured to accommodate a user sitting in the chair 110. The single suspension web 122 additionally includes two caps 156 on ends of the plurality of bamboo strips 148. The caps 156 each partially wrap around the frame.

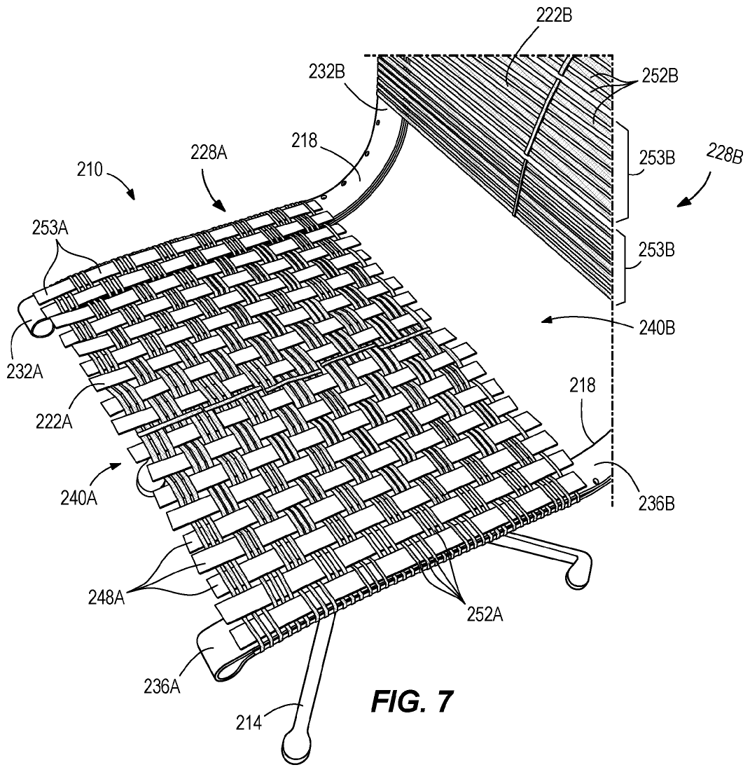

FIG. 7 illustrates another chair 210. The chair 210 is similar to the chairs 10, 110 described above and includes a base 214, a support column, a tilt mechanism, a frame 218, a first suspension web 222A, and a second suspension web 222B. Unlike the chairs 10, 110 described above, an elastically deformable layer of the first suspension web 222A includes a first plurality of elastomeric straps 252A, and an elastically deformable layer of the second suspension web 222B includes a second plurality of elastomeric straps 252B. In the illustrated embodiment, the elastomeric straps 252A, 252B are identical to one another. In other embodiments, the elastomeric straps 252A of a seat 228A may be a different material than elastomeric straps 252B of a backrest 228B. The first suspension web 222A includes a plurality of bamboo strips 248A woven with the plurality of elastomeric straps 252A. The second suspension web 222B also includes a plurality of bamboo strips (not shown) woven with the plurality of elastomeric straps 252B. In the illustrated embodiment, the bamboo strips 248A are woven with the plurality of elastomeric straps 252A in a basket pattern. In other embodiments, the bamboo strips 248A and elastomeric straps 252A can be woven in different weave patterns such as but not limited to plain, twill, satin, oxford, houndstooth, and herringbone. In other embodiments, the bamboo strips may be layered on and secured to the elastomeric straps. In other embodiments, the bamboo strips may be woven with a fabric, or with a plurality of fabric straps to form a composite which is layered on and secured to the elastomeric straps.

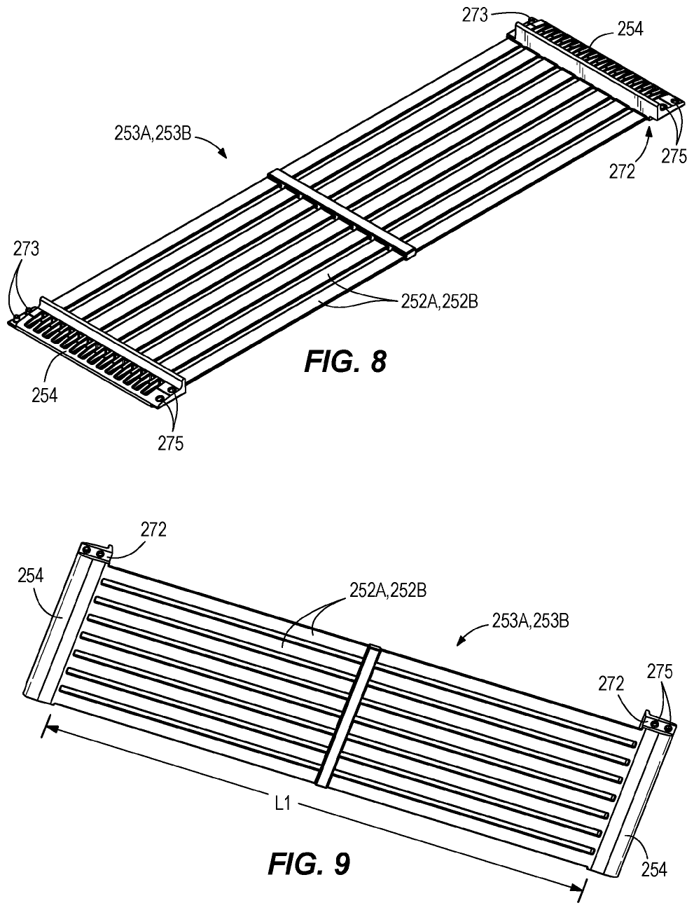

As illustrated in FIGS. 8 and 9, the elastomeric straps 252A, 252B are grouped into elastomeric segments 253A, 253B which each include a number of the elastomeric straps 252A, 252B. The elastomeric straps 252A, 252B are spaced from one another. Each of the elastomeric segments 253A, 253B includes coupling portions 254 positioned on each end of the elastomeric straps 252A, 252B. In the illustrated embodiment, the coupling portions 254 and elastomeric straps 252A, 252B are molded as one-piece. In some embodiments, the elastomeric straps 252A, 252B may be separate from and coupled to the coupling portions 254. The elastomeric segments 253A, 253A can be formed with a variety of elastomers, such as a thermoplastic polyester elastomer.

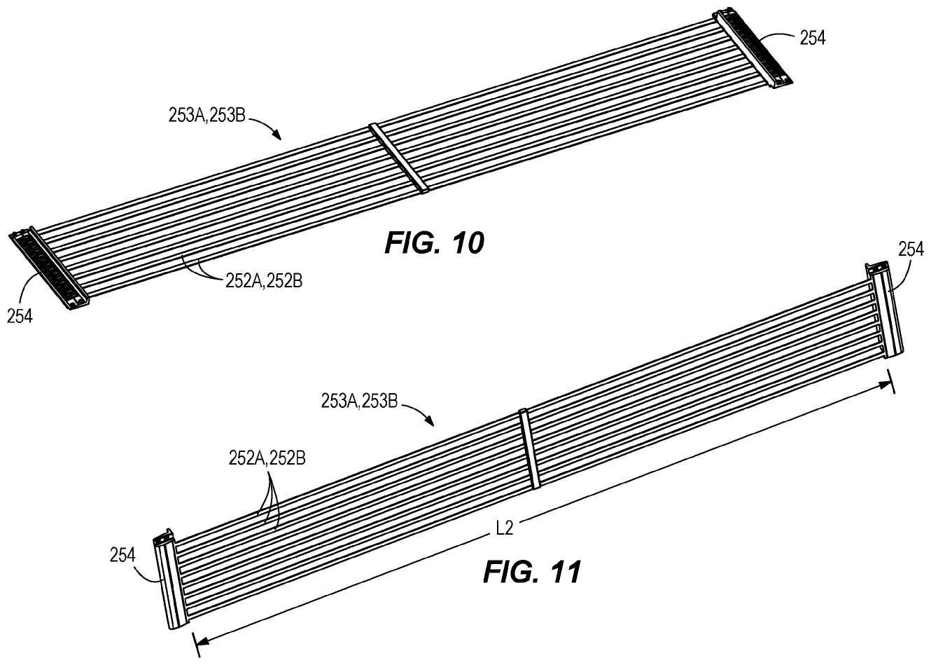

After molding, the elastomeric straps 252A, 252B have an unstretched length L1 (see FIGS. 8-9). The elastomeric straps 252A, 252B are stretched to a stretched length L2 (see FIGS. 10-11) which is larger than the unstretched length L1. Consequently, individual widths of the elastomeric straps 252A, 252B are reduced after stretching, and spaces between the elastomeric straps 252A, 252B are widened after stretching. The stretched length L2 is smaller than a gap 240A, 240B formed between first frame members 232A, 232B of the frame 218 and second frame members 236A, 236B of the frame 218. When the elastomeric straps 252A, 252B are coupled to the frame 218, the elastomeric straps 252A, 252B are further stretched over the gap 240A, 240B formed between first frame members 232A, 232B of the frame 218 and second frame members 236A, 236B of the frame 218.

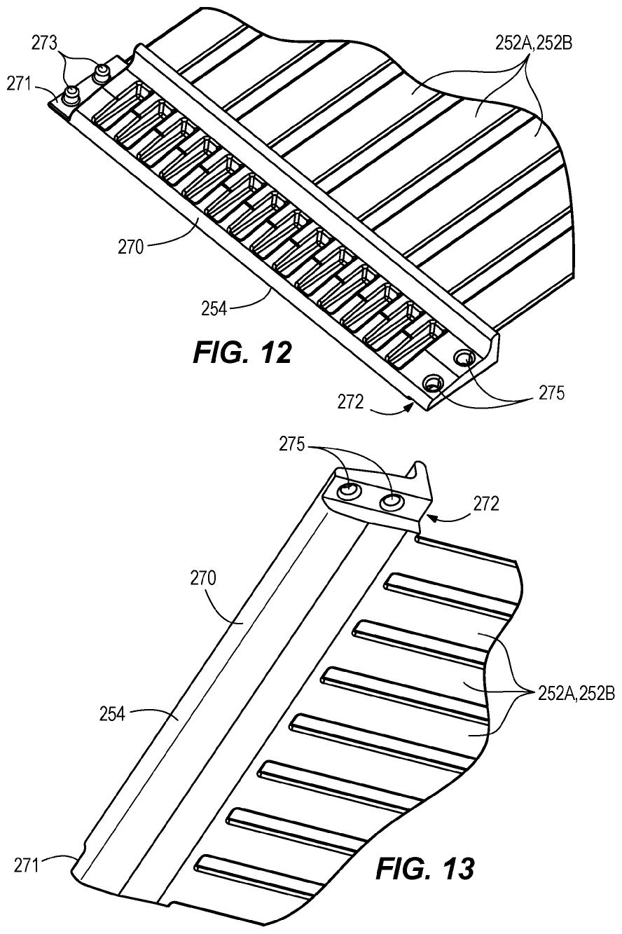

FIGS. 12 and 13 illustrate one of the coupling portions 254 of the elastomeric segments 253A, 253B. Each of the coupling portions 254 includes a main body 270, a ledge 271 extending from the main body 270, and a cutout 272 in the main body 270. The cutout 272 is configured to receive a ledge 271 of an adjacent coupling portion 254 of an adjacent elastomeric segment 253A, 253B. The ledge 271 includes a plurality of projections 273. In the illustrated embodiment, the plurality of projections 273 includes two projections 273. In other embodiments, the plurality of projections 273 may include more projections or may be replaced with a single projection. In the illustrated embodiment, the projections 273 are cylindrical. In other embodiments, the projections may have different shapes (e.g., cuboidal, prismatic, etc.). The main body 270 includes a plurality of openings 275 in a region of the cutout 272. The two openings 275 correspond to and are configured to receive projections 273 of an adjacent elastomeric segment 253A, 253B in order to secure the elastomeric segments 253A, 253B to each other.

Referring back to FIG. 7, when the suspension webs 222A, 222B are coupled to the frame 218, the coupling portions 254 of the elastomeric segments 253A, 253B are retained in recesses of the first frame members 232A, 232B of the frame 218 and the second frame members 236A, 236B of the frame 218. The elastomeric straps 252A are directly coupled to the frame 218. The bamboo strips 248A are indirectly coupled to the frame 218 by being woven with the elastomeric straps 252A. When the suspension webs 222A, 222B are coupled to the frame 218, the elastomeric straps 252A, 252B are the primary load carrying members of the chair 210.

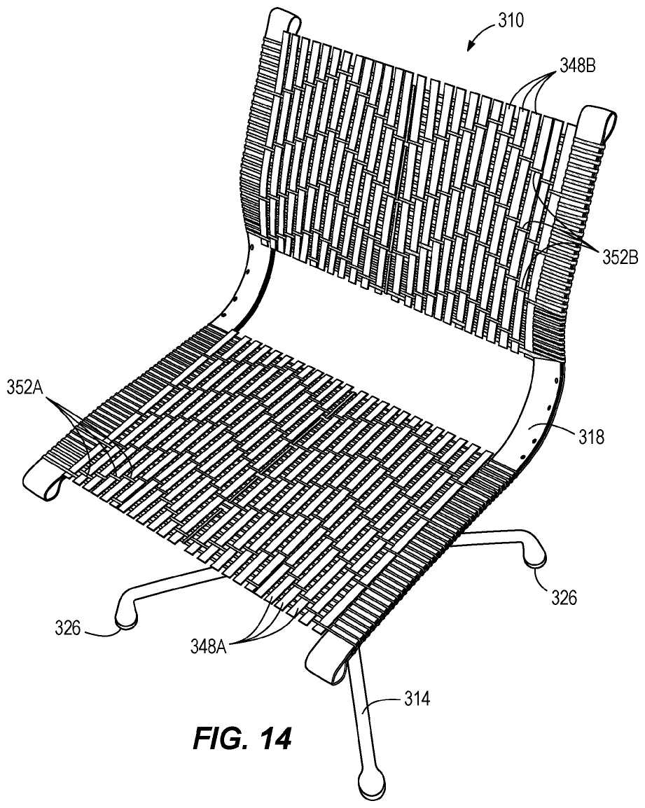

FIG. 14 illustrates another chair 310. The chair 310 is similar to the chairs 10, 110, and 210 described above and includes a base 314, a support column, a tilt mechanism and a frame 318. Unlike the chair 10, the chair 310 has a plurality of glides 326 on the base 314. Unlike the chair 310, elastomeric straps 352A, 352B and bamboo strips 348A, 348B are woven in a chevron twill weave.

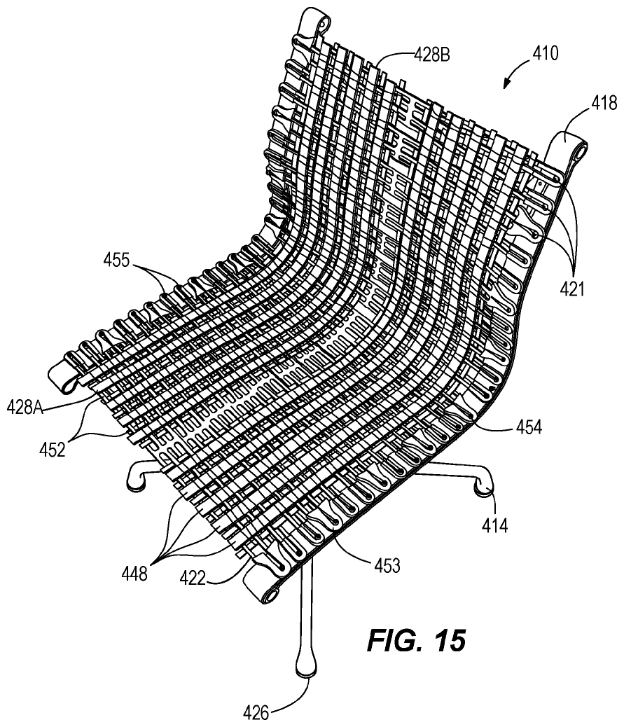

FIG. 15 illustrates another chair 410. The chair 410 is similar to the chairs 10, 110, 210, 310 described above and includes a base 414, a support column, a tilt mechanism and a frame 418. Unlike the chair 10, the chair 410 has a plurality of glides 426 on the base 414. Unlike the chair 310 and like the chair 110, the chair 410 includes a single suspension web 422 which in combination with the frame 418 forms a continuous seat 428A and backrest 428B. Additionally, unlike the chair 310, the elastomeric straps 452 are coupled to the frame 418 via a plurality of fasteners 421. Unlike the chairs 10, 110, 210, 310 described above, the suspension web 422 has a plurality of bamboo strips 448 which have varying thicknesses.

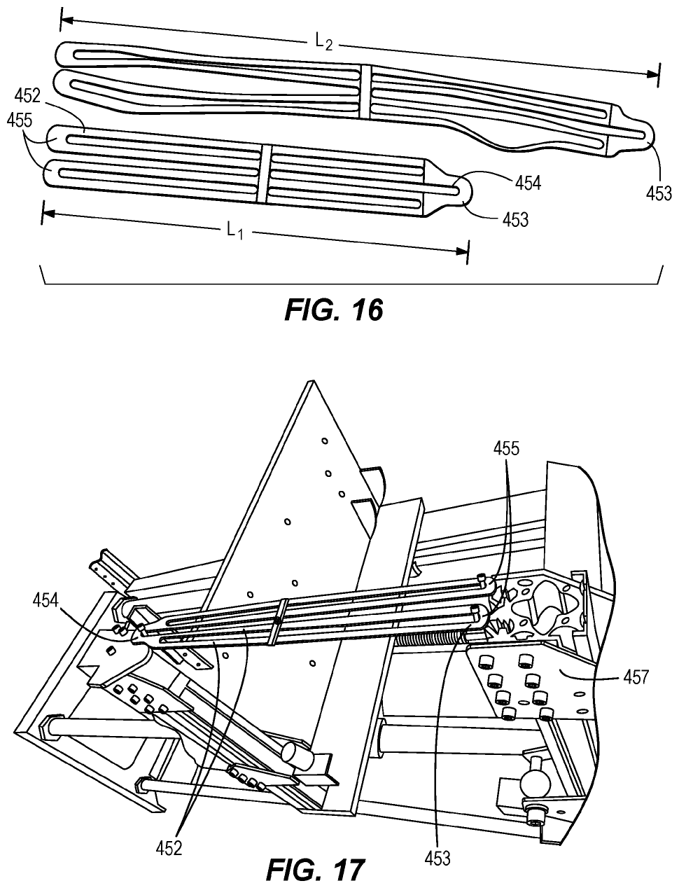

As illustrated in FIG. 16, the elastomeric straps 452 are grouped into elastomeric segments 453 which each include a number of the elastomeric straps 452. The elastomeric straps 452 are spaced from one another. Each of the elastomeric segments 453 includes a first coupling portion 454 positioned on a first end of the elastomeric straps 452 and a second coupling portion 455 positioned on a second end of the elastomeric straps 452. The first coupling portion 454 includes a loop, and the second coupling portion 455 includes two loops. In other embodiments, the coupling portions 454, 455 can include openings or projections.

After molding, the elastomeric straps 452 have an unstretched length L1. The elastomeric straps 452 are stretched to a stretched length L2 which is larger than the unstretched length L1. With reference to FIG. 17, the elastomeric segments 453 are held on a stretching machine 457 via the coupling portions 454, 455. The coupling portions 454, 455 are pulled away from each other such that the elastomeric straps 452 are stretched to the stretched length L2.

Referring back to FIG. 15, after the elastomeric straps 452 are stretched, the elastomeric straps 452 are coupled to the frame 418 by securing the coupling portions 454, 455 to the fasteners 421 on the frame 418. Some of the bamboo strips 448 are then woven into the elastomeric straps 452, and some of the bamboo strips 448 are sewn to the elastomeric straps 452 to form the continuous scat 428A and backrest 428B.

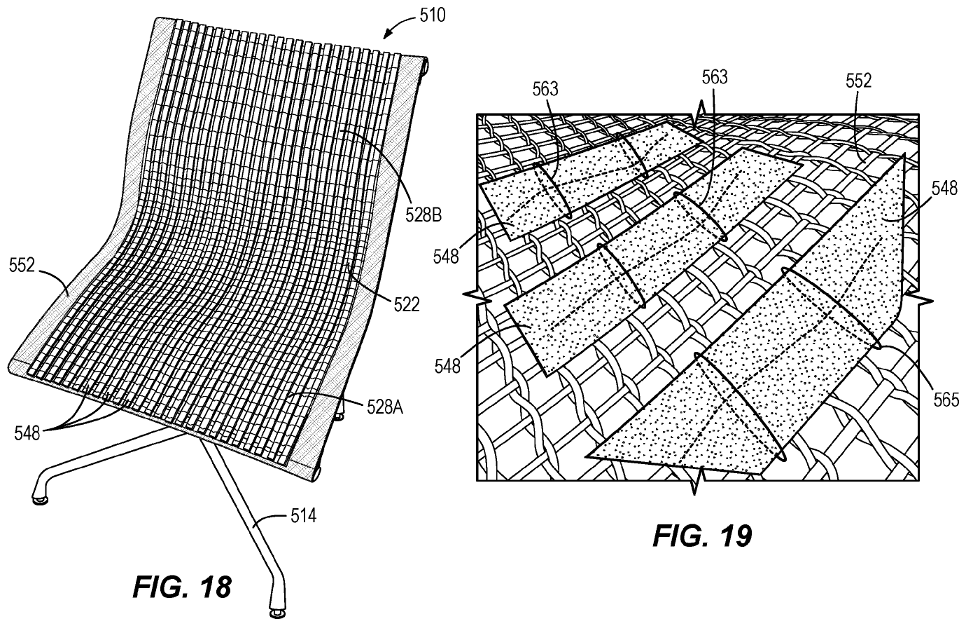

FIG. 18 illustrates another chair 510. The chair 510 is similar to the chairs 10, 110, 210, 310, 410 described above and includes a base 514, a support column, a tilt mechanism and a frame. Unlike the chair 310 and like the chairs 110, 410, the chair 510 includes a single suspension web 522 which in combination with the frame forms a continuous seat 528A and backrest 528B. Unlike the chairs 10, 110, 210, 410 described above, an elastically deformable layer of the suspension web 522 includes a sheet of suspension material 552. “Sheet” should be understood to mean a broad continuous surface. The sheet of suspension material 552 is coupled to the frame via a recess and keder. In other embodiments, the chair may also include a carrier which is coupled to the frame and on which the suspension material 552 is fixed.

The sheet 552 is formed from suspension material. The suspension material may be made of a woven or knit material, including various elastomeric materials, fabrics, or various molded polymeric materials. The suspension material can include one or more monofilaments interlaced with one or more multifilament strands. Alternatively, the suspension material can include only monofilaments and no multifilament strands. The monofilaments can be the primary load carrying members and run laterally in the warp direction of the sheet 552. The multifilament strands run longitudinally in the weft direction. Additionally, monofilaments and/or multifilaments may be combined to run in both the lateral and longitudinal directions if necessary. In the illustrated embodiment, the monofilaments of the sheet 552 run between frame members of the frame. In other words, the primary load carrying members run between frame members of the frame.

FIG. 19 illustrates the stitching of the bamboo strips 548 to the sheet 552. The bamboo strips 548 are inserted in a plurality of channels in the sheet 552 such that a front surface of the bamboo strips 548 is flush with a front surface of the sheet 552. The bamboo strips 548 are secured on the sheet 552 via surgical stitches formed from monofilaments 565 and braided lines 563. In other embodiments, the bamboo strips 548 can be coupled to the sheet 552 via other stitches such as double thread running stitches or single thread back stitches.

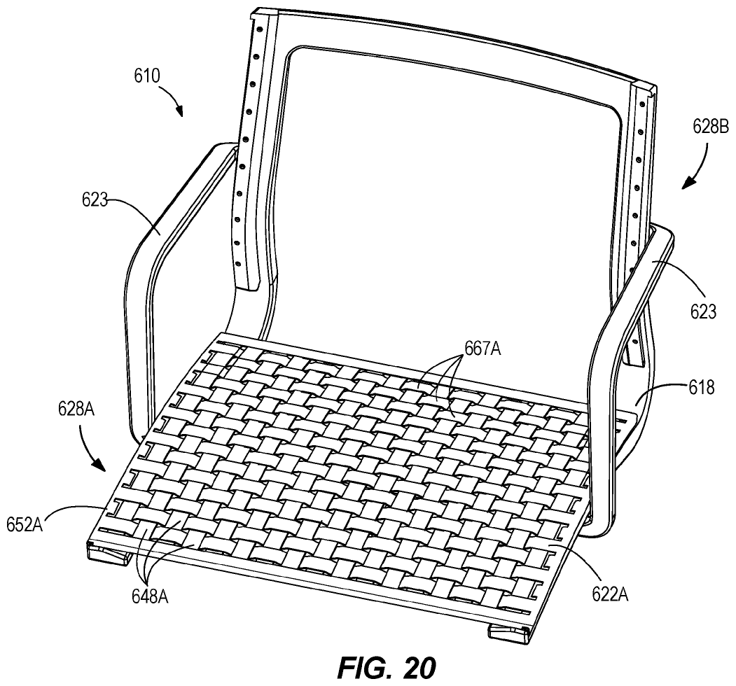

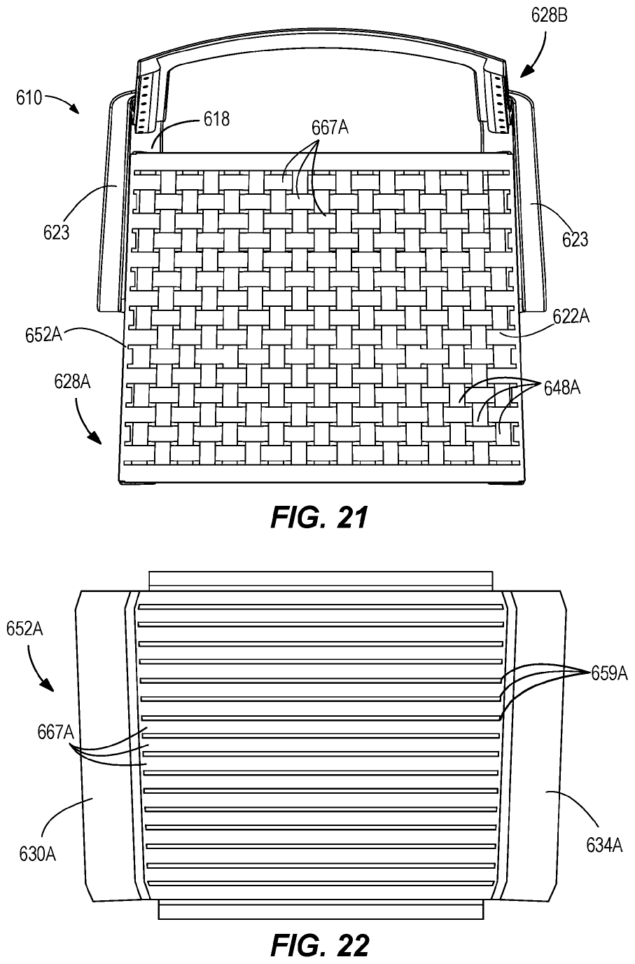

FIGS. 20 and 21 illustrate another chair 610. The chair 610 is similar to the chairs 10, 110, 210, 310, 410, 510 described above and includes a base, a support column, a tilt mechanism, a frame 618, a first suspension web 622A, and a second suspension web. In some embodiments, the support column and the tilt may be omitted. In such embodiments, base may include legs to support the frame 618. While only the first suspension web 622A is shown, it should be understood that the second suspension web is a mirror image of the first suspension web 622A shown in FIGS. 20 and 21. As such, the first suspension web 622A and the frame 618 form a seat 628A. The second suspension web and the frame 618 form a backrest 628B. In some embodiments, the chair 610 may include a single suspension web that forms a continuous seat and backrest (similar to the chairs 110, 410, 510 shown in FIGS. 6, 15, and 18). In some embodiments, the backrest 628 may be formed of a different type of suspension web or may include, for example, a cushion or pad. Alternatively, the backrest 628B may be formed of the second suspension web, but the seat 628A may be formed of a different type of suspension web or may include, for example, a cushion or pad.

Unlike the chairs 10, 110, 120, 210, 310, 410, 510 described above, the chair 610 includes armrests 623 coupled to the frame 618. Unlike the chairs 10, 110, 210, 310, 410, an elastically deformable layer of the first suspension web 622A includes a sheet of suspension material 652A (FIG. 22), rather than individual straps or groups of straps. Unlike the chair 510, the sheet of suspension material 652A has a plurality of slots 659A, thereby forming a plurality of suspension straps 667A. The sheet of suspension material 652A also has a first end 630A and a second end 634A configured to be securely coupled to the frame 618. The ends 630A, 634A may be coupled to the frame 618 via, for example, any of the attachment mechanisms described above with respect to the chair 10 of FIG. 1.

A plurality of bamboo strips 648A of the first suspension web 622A are woven with the sheet of suspension material 652A. Specifically, the bamboo strips 648A extend through the plurality of slots 659A to be woven with the suspension straps 667A. In the illustrated embodiment, the sheet of suspension material 652A has 16 slots 659A. In some embodiments, the sheet of suspension material 652A can have more or less than 16 slots 659A. Each slot 659A of the sheet of suspension material 652A has a width ranging between 4 mm and 6 mm, and is preferably 5 mm.

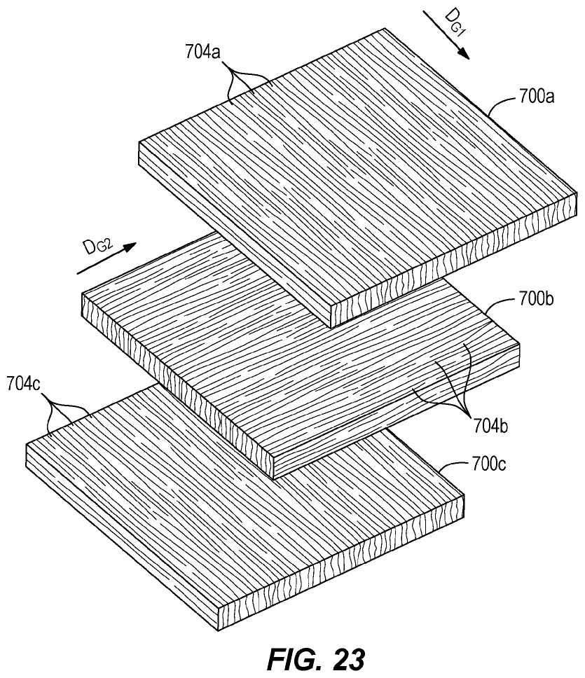

FIG. 23 illustrates a laminated bamboo sheet that can be used to form any of the bamboo strips described above. The illustrated laminated bamboo sheet includes a first bamboo layer 700a, a second bamboo layer 700b, and a third bamboo layer 700c. Each bamboo layer 700a-700c has bamboo grains 704a-704c extending along a length of each bamboo layer 700a-700c. The bamboo layers 700a-700c are configured to be laminated together by an adhesive (e.g., glue) to form the laminated bamboo sheet. Before laminating the bamboo layers 700a-700c together, each bamboo layer 700a-700c is oriented such that the bamboo grains 704a-704c extend in different directions. As illustrated, the first bamboo layer 700a is oriented such that the bamboo grains 704a extend in a first grain direction D_{G1}. The second bamboo layer 700b is oriented such that the bamboo grains 704b extend in a second grain direction D_{G2}. In the illustrated embodiment, the second grain direction D_{G2} is perpendicular to the first grain direction D_{G1}. In other embodiments, the second grain direction D_{G2} may be at other angles (e.g., 45 degrees, 30 degrees, etc.) relative to the first grant direction D_{G1}. The third bamboo layer 700c is oriented such that the bamboo grains 704c extend in the first grain direction D_{G1}. In other embodiments, the bamboo grains 704c of the third bamboo layer 700c may extend in other directions.

Once the bamboo layers 700a-700c are laminated together, the laminated bamboo sheet can be cut to produce individual laminated bamboo strips. Before cutting the laminated bamboo sheet, the adhesive is properly cure to inhibit delamination. As such, the plurality of bamboo strips used for each seating structure 10, 110, 210, 310, 410, 510, 610 may be laminated bamboo strips. Each laminated bamboo strip has a thickness ranging between 1 mm and 4 mm, and is preferably about 1.5 mm. In other embodiments, each laminated bamboo strip has a thickness that is preferably 2 mm. The laminated bamboo strips are durable and have a long lifespan.

In some embodiments, the bamboo strips may be made of fewer or more layers, such as two layers, four layers, and the like. Alternatively, the bamboo strips may not be made of a laminated material and may instead include a single layer of material.

Although the invention has been described with reference to certain embodiments, variations and modifications exist within the scope and spirit of the invention. For example, features of one embodiment may be used in combination with features of another embodiment. As such, in some embodiments, the seat and the backrest of a chair may be different. For example, the seat may include bamboo strips woven with suspension straps, while the backrest may include bamboo strips woven with elastomeric straps, or vise versa. Alternatively, only one of the seat or the backrest may include bamboo strips, while the other of the seat or the backrest includes a conventional suspension sheet with no bamboo strips or a foam cushion covered in a fabric. In addition, other natural or synthetic materials having similar properties to bamboo strips may be used in place of the bamboo strips.

Various features and advantages of the invention are set forth in the following claims.

What is claimed is:

1. A seating structure comprising:
a frame defining an opening; and
a suspension web coupled to the frame and extending over the opening to form a seat, a backrest, or both, the suspension web including:
an elastically deformable layer attached to the frame, and
a plurality of bamboo strips integrated with the elastically deformable layer.

2. The seating structure of claim 1, further comprising attachment structures respectively disposed on each side of the suspension web to couple the suspension web to the frame.

3. The seating structure of claim 1, wherein the suspension web includes a first cap and a second cap, and wherein the first cap and the second cap each define a pocket such that a first end of each bamboo strip is disposed within the pocket of the first cap and a second end of each bamboo strip is disposed within the pocket of the second cap.

4. The seating structure of claim 3, wherein the first and second ends of each bamboo strip are respectively bonded to the first cap and the second cap by an adhesive.

5. The seating structure of claim 1, wherein the plurality of bamboo strips is woven with the elastically deformable layer.

6. The seating structure of claim 1, wherein the plurality of bamboo strips is sewn onto the elastically deformable layer.

7. The seating structure of claim 1, wherein the elastically deformable layer includes a plurality of elastomeric straps.

8. The seating structure of claim 1, wherein the elastically deformable layer includes a plurality of suspension straps, and wherein each suspension strap has a thermoplastic elastomer yarn.

9. The seating structure of claim 1, wherein the elastically deformable layer includes a sheet of suspension material having a thermoplastic elastomer yarn.

10. The seating structure of claim 1, wherein each bamboo strip is a laminated bamboo strip.

11. The seating structure of claim 10, wherein each laminated bamboo strip includes a plurality of layers having bamboo grains that extend in different directions.

12. A seating structure comprising:
a frame including a first frame member and a second frame member, the second frame member spaced apart from the first frame member in a first direction to define an opening therebetween; and
a suspension web extending over the opening to form a seat, a backrest, or both, the suspension web including:
a flexible layer coupled to the first frame member and the second frame member, and
a plurality of bamboo strips coupled to the flexible layer, each bamboo strip having a length and a width, wherein the lengths of the plurality of bamboo strips extend in a second direction that is perpendicular to the first direction.

13. The seating structure of claim 12, wherein the plurality of bamboo strips is spaced apart from each other in the first direction.

14. The seating structure of claim 12, wherein the flexible layer is separated into a plurality of straps, wherein each strap has a length and a width, and wherein the lengths of the plurality of straps extend in the first direction.

15. The seating structure of claim 12, wherein the suspension web includes a first cap and a second cap spaced apart from the first cap in the second direction, and wherein the first cap and the second cap each define a pocket such that a first end of each bamboo strip is disposed within the pocket of the first cap and a second end of each bamboo strip is disposed within the pocket of the second cap.

16. The seating structure of claim 15, wherein the first and second ends of each bamboo strip are respectively bonded to the first cap and the second cap by an adhesive.

17. The seating structure of claim 12, further comprising attachment structures respectively disposed on each side of the suspension web to couple the suspension web to the frame.

18. The seating structure of claim 17, wherein each of the attachment structures includes a strip coupled to the flexible layer, the strip of each attachment structure configured to be retained within a corresponding frame member to couple the flexible layer to the first frame member and the second frame member.

19. The seating structure of claim 12, wherein the plurality of bamboo strips is woven with the flexible layer.

20. A seating structure comprising:
a frame defining an opening; and
a suspension web extending over the opening to form a seat, a backrest, or both, the suspension web including:
a flexible layer secured to the frame, and
a plurality of bamboo strips supported by the flexible layer, each bamboo strip having a first end and a second end, wherein the first and second ends are movable relative to the frame.

21. The seating structure of claim 20, wherein the suspension web includes a first cap and a second cap each defining a pocket, and wherein the first end of each bamboo strip is disposed within the pocket of the first cap and the second end of each bamboo strip is disposed within the pocket of the second cap.

22. The seating structure of claim 21, wherein the first and second ends of each bamboo strip are respectively bonded to the first cap and the second cap by an adhesive.

23. The seating structure of claim 20, further comprising attachment structures respectively disposed on each side of the suspension web to couple the suspension web to the frame.

24. The seating structure of claim 20, wherein the plurality of bamboo strips is woven with the flexible layer.
